(19) United States
(12) Patent Application Publication
(10) Pub. No.: US 2005/0055553 A1
(43) Pub. Date: Mar. 10, 2005

(54) Authentication protocol between a sewing machine and a personal computer software

(76) Inventor: Vasilios I. Thomaidis, Thessaloniki (GR)

Correspondence Address: VASILIOS I. THOMAIDIS;14th km OF THESSALONIKI - MOUDANIA HIGHWAY, PO BOX:445, THESSALONIKI,, THERMI, PC:570 01, GR

(21) Appl. No.: 10/656,155

(22) Filed: Sep. 8, 2003

(51) Int. Cl. H04L 9/00

(52) U.S. Cl. 713/176

(57) ABSTRACT

An authentication protocol (AP) of authenticating the connection and the exclusive and mutual cooperation of a specific software (SW) stored in and executed by a personal computer (PC) or a network personal computer (NPC) interconnected with a sewing machine (SM) and utilizing a standardized communication link (CL). Actualization of this is achieved, by evaluating and validating special data signatures generated, transmitted or received by each of personal computer (PC) and sewing machine (SM). The fixed sequence of transmitting and receiving said data signatures is comprised of the following steps: personal computer (PC) initializes authentication by issuing and sending authentication initialize signature (AI) to sewing machine (SM); if sewing machine (SM) is in an appropriate state, it issues and sends to personal computer (PC), an authentication acknowledge data signature (ACK). Sequentially, sewing machine (SM) issues and sends request data signature (AQD) to personal computer (PC); personal computer (PC) then issues and sends authentication response signature (ARS) to sewing machine (SM) sequentially followed by the issue and the transmission of an authorization response data signature (ARD). On the final step, sewing machine (SM) issues and sends authentication confirm signature (ACD) to inform the personal computer (PC) that the connection is authenticated and correctly established. If any of said authentication data signatures (AI), (ACK), (AQD), (ARS), (ARD), (ACD) is corrupt, missing or invalid, sewing machine (SM) function is suspended; software (SW) execution is halted or terminated.

### CROSS-REFERENCE TO RELATED APPLICATIONS

Not applicable

### STATEMENT REGARDING FED SPONSORED R&D

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

1. Field of the Invention

The invention presented hereby, is generally in the field of data processing, standardized communication protocols between hardware devices, as well as cryptography; it is specifically directed to serve as a simple protection mechanism that restricts a sewing machine to function exclusively bundled with dedicated personal computer software. The invention also concerns the use of microprocessors technology.

2. Description of Related Art

Current technology of sewing machines has been restricted into the boundaries of using one or more dedicated microprocessor chips programmed to implement the whole of machine's functionality. Their programming has been sometimes so overwhelming—even for simpler tasks—that it was non-affordable or vastly time-consuming for the designer.

Nowadays, the aspired growth of sophisticated computers, are undoubtedly becoming more and more popular each day. Most of these computers are commonly referred to as “IBM compatible”. This aspect also applies to all of its contiguous apparatuses (like Palm PCs and Macintosh). Thus, one of the most useful applications could be the use of a personal computer to communicate with and control a large amount of different devices.

A typical personal computer can communicate with these devices through several and different types of standardized communication ports that it's equipped with. To achieve this, a personal computer processor needs to be controlled by executing a software code that is stored on a storage media and then loaded into a memory. Software code instructs personal computer's processor of several and different tasks that must be carried out; one of these tasks is the communication with the hooked device.

One of these multitudinous types of devices that a personal computer can communicate with, is a sewing machine that has the capability to communicate via a suitable wired or wireless communication port.

Personal computer ports have been standardized in various types, formats and versions like a Universal serial bus, RS232 port, Parallel port, IEEE-1394, Bluetooth, Infrared and many more. Standardization assures full compatibility between personal computer and the hooked sewing machine, through any way of connection. In order to do this, these sewing machines are equipped with a microprocessor that executes the code preloaded usually in an Electrically Erasable Programmable Read-Only Memory or any other type of Read-Only Memory.

Some aspects of the designs like these explained in the “Detailed Description of the Invention” section presented hereby, require a mutual authorization for both specific personal computer software and a specific sewing machine in order to assure the valid and exclusive cooperation for both of the personal computer software and the sewing machine. In another words, the specific personal computer software can cooperate only when it communicates with a specific sewing machine and vice versa; the sewing machine can only operate if it is controlled by only a certain personal computer program. Hence, it's assumed that both personal computer and sewing machine follow a predefined sequence of transmissions and receptions of data signatures through their communication ports, in order to mutually validate their exclusive—bundled—cooperation.

Thus, there's a need for an authentication protocol that assures that such a cooperation can only be established if the personal computer issues (by means of a software and through its communication port) a fixed sequence of specific data signatures that are recognized and accepted by the sewing machine and vice versa: the sewing machine in turn, issues a very specific sequence of data signatures that are recognized and accepted by the software that is executed by the personal computer.

### BRIEF SUMMARY OF THE INVENTION

This invention seeks to provide a cooperation authentication protocol (AP) to a pair of correspondents personal computer (PC) equipped with its appropriate software (SW) and a sewing machine (SM), electrically or wirelessly connected in order to establish a valid communication link (CL) and, therefore, permit further exchange of information between them. The complete authentication procedure takes place during their initial communication and before any other transaction that could occur between them which carries stitching data in any format. Stitching data format can be of any standardized type like encrypted data, compressed data or raw data.

In accordance with the aspects of the invention, this authentication protocol (AP) consists of six independent steps, in a strict sequence.

Each step is implemented by issuing the data signature from either the personal computer (PC) or the sewing machine (SM) and its transmission though the relative communication port. The transaction continues with the reception of the said data signature from the sewing machine (SM) or the personal computer (PC) respectively, the storage of the received data signature into a temporary or permanent memory and at the end, the validity evaluation of the data signature.

After a successful authentication procedure, both personal computer (PC) and the sewing machine (SM) are allowed to exchange stitching data. This state is valid until the end of the cooperation session; a cooperation session can be considered as “ended” either when the personal computer software (SW) execution is terminated by any means or when the sewing machine (SM) operation is terminated by any means or when the communication link (CL) between personal computer (PC) and the sewing machine (SM) is interrupted or lost, by any means too. Also, a session ends when one stitching data transmission from personal computer (PC) to sewing machine (SM), is successfully completed; authentication procedure needs to be re-launched in order to send another pack of stitching data. The case of resetting or restarting either personal computer (PC) or sewing machine (SM) is also indicating an ended session. In any of the above cases, in order to re-allow data to be exchanged between personal computer (PC) and the sewing machine (SM), the authentication procedure must be repeated right from the start.

### BRIEF DESCRIPTION OF DRAWINGS

These and other features of the present invention will become more apparent from the description of preferred embodiments of this invention, which are described by way of example, only, with reference to the accompanying drawings in which like elements have been assigned like letters and wherein:

FIG. 1 is a schematic diagram of a personal computer (PC) interconnected with a sewing machine (SM) by means of a communication link (CL); cooperation authentication protocol (AP) is implemented prior to normal cooperation. Two-sided arrows indicate a bi-directional communication between the indicated elements. The memory of the personal computer (PC) is referred as “RAM” and the memory of the sewing machine (SM) as “SRAM”. The processor of the personal computer (PC) is referred as “CPU”; processor of the sewing machine (SM) is referred as “Microprocessor”.

FIG. 2 is a schematic diagram of a personal computer (PC) interconnected with a sewing machine (SM) by means of a communication link (CL); personal computer (PC) is connected with a second network personal computer (NPC) by utilizing a network (NET). As mentioned in par. [0018], two-sided arrows indicate a bi-directional communication between the indicated elements. The memory of the personal computer (PC) is referred as “RAM”; the memory of the sewing machine (SM) as “SRAM”; the memory of the network personal computer (NPC) as “NRAM”. The processor of the personal computer (PC) is referred as “CPU”; processor of the sewing machine (SM) is referred as “Microprocessor”; processor of the network personal computer (NPC) is referred as “NCPU”. Network cards for the personal computer (PC) and the network personal computer (NPC) are referred as “NC1” and “NC2” accordingly.

FIG. 3 is a flow diagram of the complete authentication protocol (AP) which shows the sequence of steps that authentication protocol (AP) is consisted of. Arrows indicate the data flow direction for each of the steps of the authentication protocol.

### DETAILED DESCRIPTION OF THE INVENTION

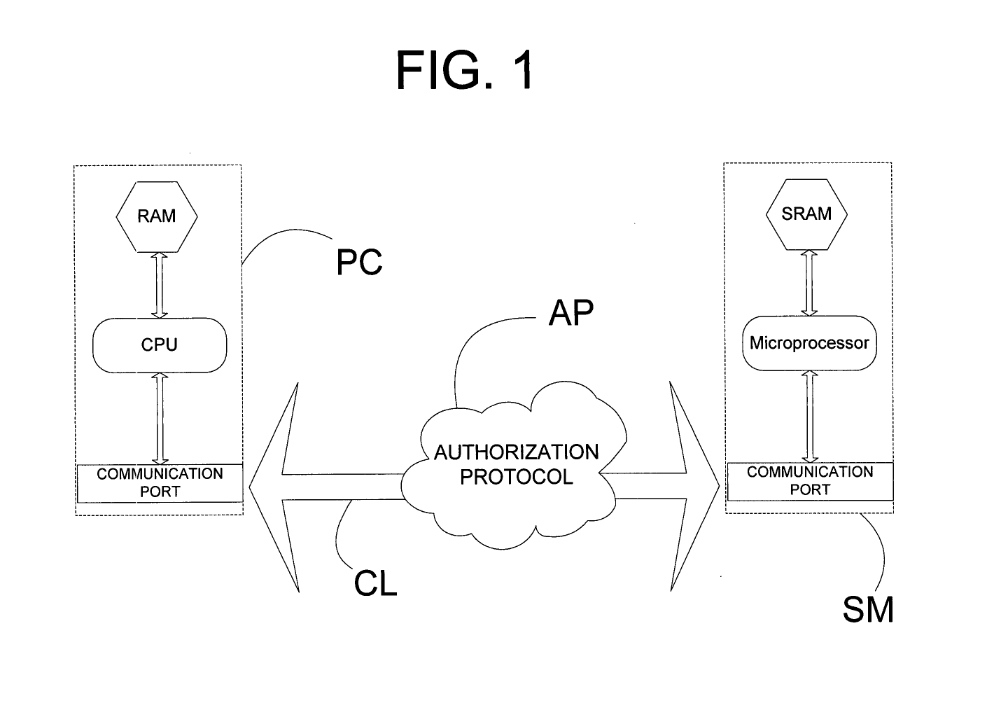

In the first aspect of our invention and referring to FIG. 1, personal computer (PC) is configured and equipped with a standardized Universal Serial Bus communications port. This type of communications port is selected in all the aspects of our design described hereby.

Apart from a USB port, several other types of standardized communications ports can also be utilized in the same way. These types include the Parallel communications port, RS232, IEEE 1394 type port, Firewire®, InfraRed and Wi-Fi®.

Personal computer (PC) presented in FIG. 1, is at least equipped with: a processor chip that is capable of executing various commands which are prescribed by said software (SW); during normal operation, said software (SW) is stored into memory device that processor chip is connected to. For the sake of clarity, personal computer (PC) processor chip will hereafter also be referred as “CPU”.
a memory device that holds and exchanges temporary execution data from and towards said CPU. For the sake of clarity, this memory device will hereafter also be referred as “RAM”
at least one type of the communications ports mentioned in par. [0022]; communication port exchanges information with CPU and RAM through a local wired bus.

Optionally, said personal computer (PC) may also include in its configuration:
any kind of storage media or mass storage device properly connected to said personal computer (PC), in which said dedicated software (SW) is permanently or temporarily stored. Mass storage devices can be any kind of magnetic storage media (i.e. floppy disks or Hard Disk Drives) or optical storage media (i.e. CD-ROM disk).
a monitor, television set, video projector, or any other kind of visualization device properly connected to said personal computer (PC), that helps said personal computer (PC) user to function and control it visually.
a keyboard, mouse, touch screen, boutonniere, or any other kind of data input device that could enable user to feed said personal computer (PC) with certain input data.
a network connection device—commonly referred to as a “Network Card” that enables personal computer (PC) user to be connected to other personal computers or any kind of mass storage devices. These network personal computers include said dedicated software (SW) that can also be executed by said network personal computer by means of a network connection. Network connection of wired type can be any type of the standardized protocols like the “IP Protocol suite”. Correspondingly, wireless connection can be accomplished by means of any standardized protocol utilizing a radio frequency or an optical beam of any wavelength and method of modulation; the case of utilizing network personal computers will be explained in the second aspect of the invention, in detail.

On the other side, said sewing machine (SM) is consisted of at least the following parts:
a microprocessor chip that is capable of executing various commands that are stored either in its integrated memory (commonly called “Electrically Erasable Programmable Memory-EEPROM”) or stored into an external (off-the-body) memory device that microprocessor chip is connected to. For the sake of clarity, this microprocessor chip will be referred to as “microprocessor” and sewing machine memory will also be referred as “SRAM”. Electronics market offers a vast range of microprocessors with different working specifications like their working frequency, integrated memory size, command byte length, command set and many more. This embodiment may utilize any type of microprocessor.
at least one type of the communications ports mentioned in par. [0022]; communication port exchanges information with microprocessor and SRAM through a local wired or wireless bus.

In order to allow both personal computer (PC) and sewing machine (SM) to exchange data and generally cooperate, a proper communication link (CL) must be established. This is achieved by linking personal computer (PC) communications port, with the according sewing machine's (SM) communication port.

A communication link (CL) can be acted out, utilizing standard communication ports including these mentioned in par. [0022].

In the case of a wired communication link (CL) like a Parallel port connection, a Universal Serial Bus connection, an IEEE-1394 connection or a Firewire® connection, a proper cable will be needed. Each type of those connection types must follow certain conductor wirings that are prescribed by the relevant standard it is bind to.

An infrared or any other optics-based communication link (CL) requires the mandatory transition of optical signals from said personal computer (PC) communications port to said sewing machine (SM) communication port and vice versa; the transition of optical signals from said sewing machine (SM) communication port to the corresponding personal computer (PC) communication port.

Accordingly, a Wi-Fi® or any other similar communication link (CL) presupposes the existence of one or more radio frequency carriers that are properly modulated in such way so as to achieve the mutual reception or transmission of data between the personal computer (PC) and the sewing machine (SM)

In the first aspect of our invention, that is schematically presented in FIG. 1, a standardized “Universal Serial Bus” type serial communication link (CL) is utilized, in order to clearly explain the realization of the authorization protocol (AP) invented.

Assuming communication link (CL) connection is already established, the software (SW) is loaded into personal computer memory (RAM) and the microprocessor executes program code previously stored in its memory (SRAM), the authentication protocol procedure launches during the power-up or on every start up of both of the personal computer (PC) and the sewing machine (SM).

Also, it is hereafter assumed that the data signatures transmitted by either personal computer (PC) communication port or the sewing machine (SM) communication port, are preceded and followed by an indefinable number of control bytes required by each of the standard communications protocol used.

A data signature consists of one or more data bytes. For simplicity reasons, a data signature will also be referred as “data byte” (in cases of one-byte long data signature) or “data bytes” (in cases of 13-byte long data signature), hereafter.

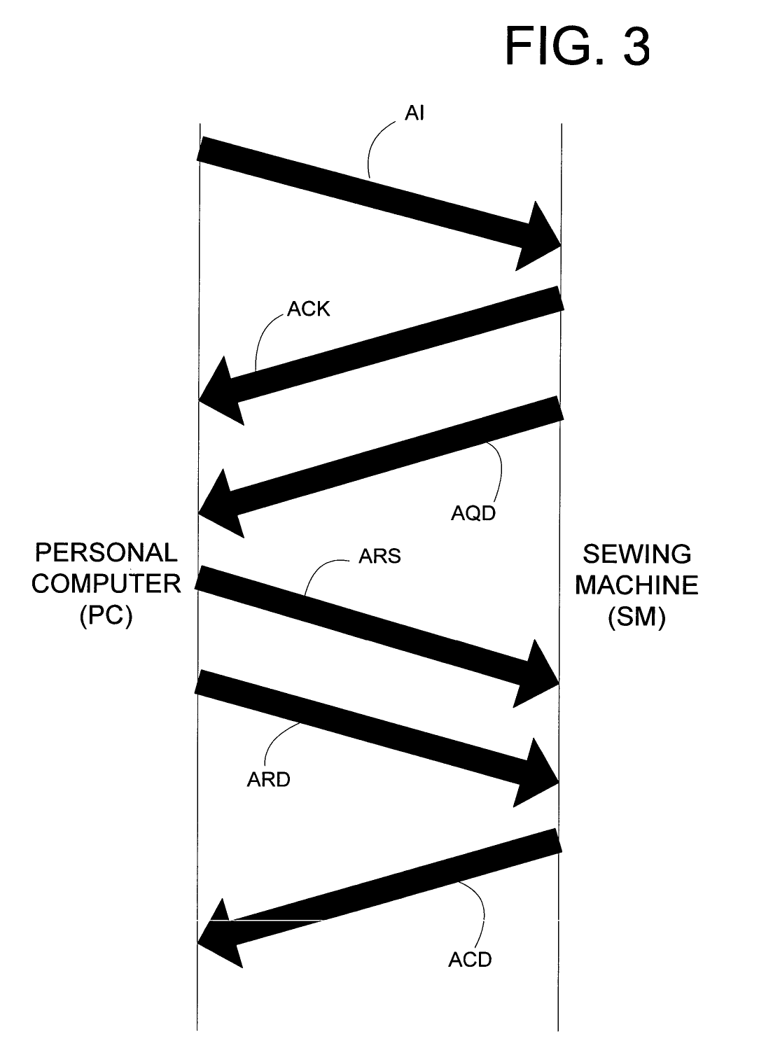

The first step of the authentication protocol (AP) concerns the said authentication initialization signature (AI) (see also FIG. 3) and is initiated by the personal computer (PC). Personal computer (PC) CPU is requested by the software (SW) to send a command or a sequence of predefined commands to personal computer (PC) communication port. Said communication port encapsulates these commands into in an appropriate data packet that is transmitted though the communications link (CL) to the sewing machine (SM) communication port. Successively, the sewing machine (SM) communication port receives the transmitted data packet and microprocessor takes charge of the transfer of said data packet to microprocessor's memory (SRAM).

Sewing machine (SM) microprocessor extracts the data byte, stores it into the memory (SRAM) and then analyses its value.

If the value of the received data byte is not equal to 8 E (using the hexadecimal units system), the microprocessor is instructed to end further commands execution. Process of authentication protocol (AP) implementation must be restarted for both personal computer (PC) and sewing machine (SM).

If the value of the received data byte is 8 E (using the hexadecimal units system), the microprocessor is instructed to send the authentication acknowledge signature (ACK); this is described in the next step.

Second step of the authentication protocol (AP), concerns the said authentication acknowledge signature (ACK) (see also FIG. 3) and is implemented by the sewing machine (SM) microprocessor.

Microprocessor is requested by the program code stored in its memory (SRAM), to send a series of predefined commands to its communication port.

Sewing machine (SM) communication port interprets and encapsulates these commands into one data packet. This data packet is transmitted by the sewing machine (SM) communication port and through the communication link (CL), to the personal computer (PC) communication port; personal computer (PC) communication port waits to receive the data packet within a certain reception timeout. The data packet received is then transferred by the CPU into the memory (RAM).

Following out the software (SW) instructions, CPU analyzes the received data packet and extracts the data byte which is sequentially stored into RAM.

If the value of the received data byte is not equal to 00 (using the hexadecimal units system) or the reception timeout expires, software (SW) stops processing any further commands. Process of authentication protocol (AP) implementation must be restarted for both personal computer (PC) and sewing machine (SM).

If the value of the received data byte is equal to 00 (using the hexadecimal units system), CPU is instructed by the software (SW) to proceed to the following third step.

Third step of the authentication protocol (AP) is the transmission of said authentication request data signature (AQD) (see also FIG. 3) and is implemented by the sewing machine (SM). As in previous step, microprocessor is instructed to send a series of predefined commands to its communication port. These commands are then converted into a series of 13 bytes which comprise the authentication request data signature (AQD) that is encapsulated into a data packet and transmitted by the sewing machine (SM) communication port and via the communication link (CL), to the personal computer (PC) communication port. Personal computer (PC) communication port receives said data packet within a certain timeout, and CPU undertakes the transfer of said data packet from communication port to memory (RAM) where the extraction of the data bytes and their analysis phase will take place.

The analysis phase of this step is initiated by checking the standardized ASCII values of the second, third, fourth, fifth, sixth, seventh, eighth and ninth data byte of the received 13-byte long authentication request data signature (AQD).

Validation can be considered as successful if all of the following eight equations are true. In this case, personal computer (PC) proceeds to the forth step of the authentication protocol (AP) implementation.
1. The value of the second byte is equal to 43 h which corresponds to the capital letter “C”
2. The value of the third byte is equal to 4 Fh which corresponds to the capital letter “0”
3. The value of the fourth byte is equal to 4 Dh which corresponds to the capital letter “M”
4. The value of the fifth byte is equal to 50 h which corresponds to the capital letter “P”
5. The value of the sixth byte is equal to 55 h which corresponds to the capital letter “U”
6. The value of the seventh byte is equal to 43 h which corresponds to the capital letter “C”
7. The value of the eighth byte is equal to 4 Fh which corresponds to the capital letter “0”
8. The value of the ninth byte is equal to 4 Eh which corresponds to the capital letter “N”

If any of the above statements is false or a timeout is encountered during data bytes reception, further execution of software (SW) as well as the consequent communication with the sewing machine (SM) is prohibited. Authentication protocol (AP) deployment must be re-launched from the first step (see par. [0043])

The fourth step of the authentication protocol (AP), concerns the transmission of said authentication response signature (ARS) as presented in FIG. 3 too.

Implementation of this step is charged to the personal computer (PC) CPU which is instructed by the software (SW) to send a command or a sequence of predefined commands to personal computer (PC) communication port; communication port, in turn, interprets and encapsulates these commands to a data packet that is transmitted though the communications link (CL) to the sewing machine (SM) communication port in a certain timeout limit. Microprocessor takes charge of the transfer of the received data packet to the microprocessor memory (SRAM). Microprocessor then extracts the data byte from the data packet and analyzes its value.

If the value of the received data byte is not equal to 8 F (using the hexadecimal units system) or data byte reception timeout expires, the microprocessor is instructed to end; further command execution is not possible until restarted or reset by any means.

If the value of the received data byte is 8 F (using the hexadecimal units system), the microprocessor is instructed to send the authentication response data signature (ARD); this procedure will be described in the fifth step of our authentication protocol (AP).

The implementation of the fifth step (see also FIG. 3), is assigned to the personal computer (PC). As in the fourth step of the authentication procedure, software (SW) instructs CPU to send a set of predefined commands, to the relevant communication port of the personal computer (PC). These commands are converted into a series of data bytes which comprises the authentication response data signature (ARD); authentication response data signature (ARD) is encapsulated in a data packet and transmitted by the personal computer (PC) communication port and via the communication link (CL), is received by the corresponding communication port of the sewing machine (SM). Reception is bounded into a certain reception timeout and is followed by the transfer of the received data packet from the communication port to memory (SRAM) with the utilization of the microprocessor; this enables the consequent process of the extraction of the data bytes from the data packet, as well as their analysis phase.

The analysis phase of this step is actualized by checking the standardized ASCII values of the second, third, fourth, fifth, sixth, seventh, eighth and ninth data byte of the received 13-byte long authentication response data signature (ARD).

Validation can be considered as successful if all of the following eight equations are true. In this case, sewing machine (SM) proceeds to the ninth step of the authentication protocol (AP) implementation.
1. The value of the second byte is equal to 43 h which corresponds to the capital letter “C”
2. The value of the third byte is equal to 4 Fh which corresponds to the capital letter “O”
3. The value of the fourth byte is equal to 4 Dh which corresponds to the capital letter “M”
4. The value of the fifth byte is equal to 50 h which corresponds to the capital letter “P”
5. The value of the sixth byte is equal to 55 h which corresponds to the capital letter “U”
6. The value of the seventh byte is equal to 43 h which corresponds to the capital letter “C”
7. The value of the eighth byte is equal to 4 Fh which corresponds to the capital letter “O”
8. The value of the ninth byte is equal to 4 Eh which corresponds to the capital letter “N”

If any of the above statements is false or reception timeout expires, sewing machine (SM) microprocessor waits for a defined number of tries until it successfully receives again the data byte described in the fourth step and the data bytes described in the fifth step, sequentially. Failing to successfully validate for this defined number of tries, results in prohibiting of any further microprocessor command execution as well as the consequent communication with the personal computer (PC). Complete process of authentication protocol (AP) implementation must be restarted for both personal computer (PC) and sewing machine (SM).

The last step of the authentication protocol (AP), concerns the transmission of said authentication confirm signature (ACD) (see also FIG. 3). This step, is actualized by the sewing machine (SM) microprocessor which sends a command or a sequence of predefined commands to sewing machine (SM) communication port; communication port, in turn, interprets and encapsulates these commands to one data packet that is transmitted though the communications link (CL) to the personal computer (PC) communication port, in a certain time bound. CPU then undertakes the transfer of the received data packet from communication port to the memory (RAM), the extraction of the data byte as well as its analysis.

If the value of the received data byte is not equal to 00 (using the hexadecimal units system) or a reception timeout is encountered, the software (SW) executed in personal computer (PC) assumes this step as unsuccessful and authentication protocol (AP) procedure is restarted for both the personal computer (PC) and the sewing machine (SM).

If the value of the received data byte is 00 (using the hexadecimal units system), the software (SW) executed in personal computer (PC) assumes that authentication protocol (AP) procedure is successfully ended and the normal cooperation and data exchange with the sewing machine (SM) can be launched.

After a successful authentication procedure, the personal computer (PC) is allowed to send stitching data to the sewing machine (SM). This state is valid until the end of the cooperation session.

A cooperation session can be considered as “ended” either when the personal computer software (SW) execution is terminated by any means or when the sewing machine (SM) operation is terminated by any means or when the communication link (CL) between personal computer (PC) and the sewing machine (SM) is interrupted or lost, by any means too. Also, a session ends when one stitching data transmission is completed; authentication procedure needs to be re-launched in order to send another pack of stitching data. The case of resetting or restarting either personal computer (PC) or sewing machine (SM) is also indicating an ended session. In any of the above cases, in order to re-allow data to be exchanged between personal computer (PC) and the sewing machine (SM), the authentication procedure must be repeated right from the start.

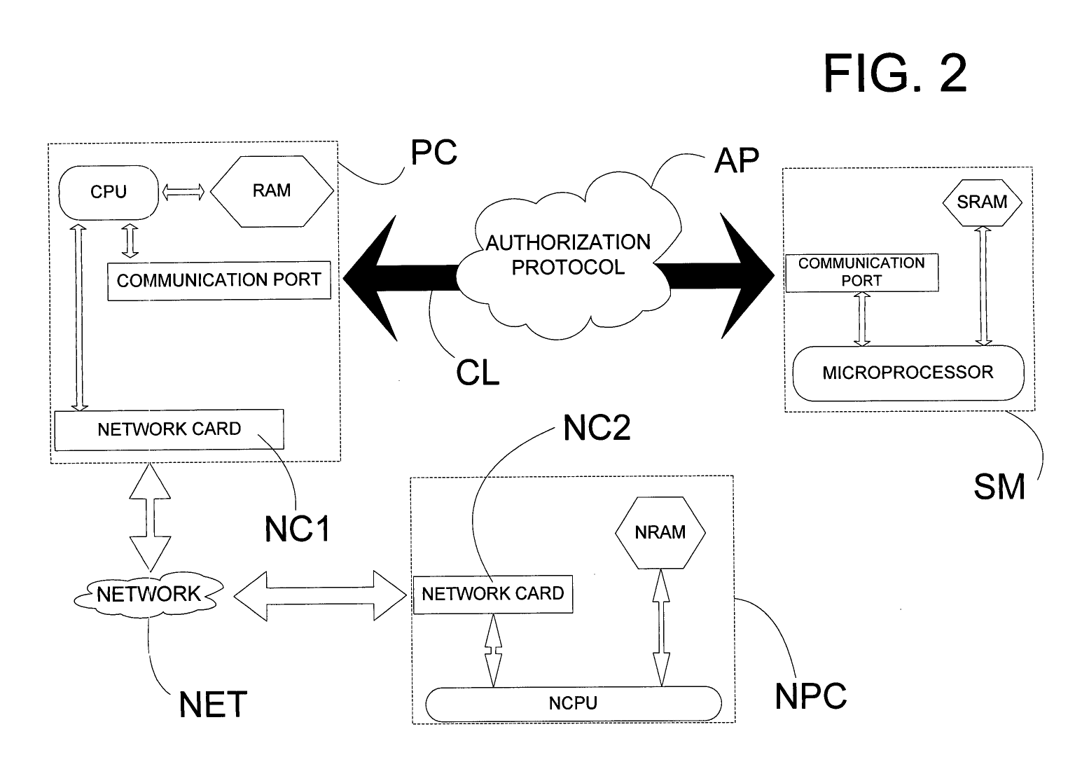

In a second aspect of our invention, that is schematically presented in FIG. 2, personal computer (PC) is configured and equipped with a standardized Universal Serial Bus communication port. This type of communication port is also used in the all aspects of our design.

Apart from Universal Serial Bus communication port, several other types of standardized communication ports can also be utilized in the same way. These types include the Parallel communications port, RS232, IEEE 1394 type port, Firewire®, InfraRed and Wi-Fi®.

Personal computer (PC) also makes use of a network connection device, in order to have the ability to be connected to a network personal computer (NPC) that is also connected to the network (NET).

For simplicity reasons, personal computer (PC) network connection device will also be referred as “NC1”; network personal computer (NPC) network connection device will also be referred as “NC2” (see also FIG. 2).

Also, for clarity reasons, it is hereafter assumed that the data bytes transmitted or received by personal computer (PC) communication port, sewing machine (SM) communication port, personal computer (PC) network card, and network personal computer network card, are preceded and followed by an indefinable number of control bytes required by the utilized communication and network protocols.

Personal computer (PC) is at least equipped with:
a processor chip that is capable of executing various commands which are prescribed by an operating system or any other software that, during normal operation, is stored into memory device that processor chip is connected to. For the sake of clarity, personal computer processor chip will also be referred as “CPU”.
a memory device that holds and exchanges temporary execution data from and towards said CPU. For the sake of clarity, memory device will also be referred as “RAM”
at least one type of the communications ports mentioned in par. [0071]; communication port exchanges information with CPU and RAM through a local wired bus.
a network connection device that enables personal computer (PC) user to be connected to other personal computers or any kind of mass storage devices. For the sake of clarity, this network connection device will also be referred as “NC1”

Network personal computer (NPC) is at least equipped with:
a processor chip that is capable of executing various commands which are prescribed by said software (SW); during normal operation, said software (SW) is stored into memory device the processor chip is connected to. For the sake of clarity, this processor chip will also be referred as “NCPU”.
a memory device that holds and exchanges temporary execution data from and towards said NCPU. For the sake of clarity, memory device will also be referred as “NRAM”.
a network connection device (NC2) that enables network personal computer (NPC) user to be connected to other personal computers or any kind of mass storage devices.

Personal computer (PC) and network personal computer (NPC) can be connected through a proper available network (NET) connection. A wired type connection can be any type of the standardized protocols like the “IP Protocol suite”. Correspondingly, a wireless type connection can be accomplished by means of any standardized protocol utilizing a radio frequency carrier or an optical beam of any wavelength and method of modulation.

Optionally, both said personal computer (PC) and network personal computer (NPC) may also include in their configuration:
a storage media or mass storage device of any kind, in which said dedicated software (SW) can be permanently or temporarily stored. Mass storage devices can be any kind of magnetic storage media (i.e. floppy disks or Hard Disk Drives) or optical storage media (i.e. a CD-ROM disk).
a monitor, television set, video projector, or any other kind of visualization device properly connected to said personal computer (PC) or network personal computer (NPC), that helps user to function and control it visually.
a keyboard, mouse, touch screen, boutonniere, or any other kind of data input device that could enable personal computer (PC) or network personal computer (NPC) user to input certain user data.

On the other side, said sewing machine (SM) is consisted of at least the following parts:
a microprocessor chip that is capable of executing various commands that are stored either in its integrated memory commonly called “Electrically Erasable Programmable Memory” or stored into an external (off-the-body) memory device the microprocessor chip is connected to. For the sake of clarity, microprocessor chip will also be referred as “microprocessor” and microprocessor memory will also be referred as “SRAM”. Electronics market offers a vast range of microprocessors with different working characteristics like their working frequency, integrated memory size, command byte length, command set and many more. This embodiment may utilize any type of microprocessor.
at least one type of the communications ports mentioned in par. [0071]; communication port exchanges information with microprocessor through a local wired or wireless bus.

In order to allow both of personal computer (PC) and sewing machine (SM) to exchange data and generally cooperate, a proper communication link (CL) must be established. This is achieved by linking personal computer (PC) communications port, with the according sewing machine's (SM) communication port.

A communication link (CL) can be acted out, utilizing standard communication ports like these mentioned in par. [0071].

In the case of a wired communication link (CL) like a Parallel port connection, a Universal Serial Bus connection, an IEEE-1394 connection or a Firewire® connection, a proper cable is need to be physically connected to each of the communication ports. Each type of those connection types must follow certain conductor wirings that are prescribed by the relevant standard it is bind to.

An infrared or any other optics-based communication link (CL) requires the mandatory transition of optical signals from said personal computer (PC) communications port to said sewing machine (SM) communication port and vice versa; the transition of optical signals from said sewing machine (SM) communication port to the corresponding personal computer (PC) communication port.

Accordingly, a Wi-Fi® or any other similar communication link (CL) presupposes the existence one or more radio frequency carriers that are properly modulated in such way so as to achieve the mutual reception or transmission of data by either the personal computer (PC) or the sewing machine (SM)

In this aspect of our invention, a standardized Universal Serial Bus type, serial communication link (CL) is utilized in order to clearly explain the realization of the authorization protocol (AP) invented.

Assuming communication link (CL) connection is already established, the software (SW) is loaded into network personal computer memory (NRAM) and the sewing machine (SM) microprocessor is executing program code previously stored in its memory (SRAM), the authentication protocol (AP) procedure launches during the power-up or on every start up of both of the network personal computer (NPC) and the sewing machine (SM).

For clarity reasons, it is hereafter assumed that the bytes transmitted by either personal computer (PC) communication port or the sewing machine (SM) communication port, are preceded and followed by an indefinable and variable number of control bytes required by the standard communications protocol.

A data signature is consisted of one or more bytes. For simplicity reasons, a 1-byte long data signature will also be referred as “data byte” and a 13-byte long data signature will also be referred as “data bytes”, hereafter.

As also presented in FIG. 3, the first step of the authentication protocol (AP) concerns the said authentication initialization signature (AI) and is actualized by the network personal computer (NPC). Network personal computer processor (NCPU) is requested, by the software (SW) loaded into its memory (NRAM), to send a command or a sequence of predefined commands to network personal computer network card (NC2). Said network card (NC2) encapsulates said commands into a data packet and sends it through the interceded network (NET) that connects both personal computer network card (NC1) and network personal computer network card (NC2) (see FIG. 2).

The data packet received by network card (NC) is then transferred by CPU into RAM. CPU sequentially transfers data packet from RAM to personal computer (PC) communication port.

Personal computer (PC) communication port transmits the data packet though the communications link (CL) to the sewing machine (SM) communication port. Successively, the sewing machine (SM) communication port receives the transmitted data packet and microprocessor undertakes the transfer of it into the sewing machine memory (SRAM).

Sewing machine (SM) microprocessor then extracts the data byte from the data packet and analyzes its value.

If the value of the received data byte is not equal to 8 E (using the hexadecimal units system), the microprocessor is instructed to end further commands execution. Process of authentication protocol (AP) implementation must be restarted for both network personal computer (NPC) and sewing machine (SM).

If the value of the received data byte is 8 E (using the hexadecimal units system), the microprocessor is instructed to send authentication acknowledge signature (ACK); this is described in the next step.

Second step of the authentication protocol (AP), concerns the said authentication acknowledge signature (ACK) and is implemented by the sewing machine (SM) microprocessor (see also FIG. 3).

Microprocessor is requested, by the commands stored in the memory (SRAM), to send a series of predefined commands to sewing machine (SM) communication port.

Sewing machine (SM) communication port interprets these commands into one data packet. This data packet is transmitted by the sewing machine (SM) communication port and, through the communication link (CL), to the personal computer (PC) communication port. Reception of the transmitted data packet is time limited. The data packet received is transferred by CPU into memory (RAM). CPU then undertakes the transfer of received data packet from RAM to the personal computer network card (NC1). Network card (NC1) utilizes the interceded network (NET) and transmits received data packet to network personal computer (NPC) network card (NC2). Successively, NCPU transfers data packet from network personal computer network card (NC2) to NRAM.

Following out the software (SW) instructions, NCPU extracts and analyzes the value of the extracted data byte.

If the value of the received data byte is not equal to 00 (using the hexadecimal units system) or the reception time runs out, software (SW) terminates and NCPU stops processing any further commands; sewing machine (SM) microprocessor ends further command execution. Process of authentication protocol (AP) implementation must be restarted for both network personal computer (NPC) and sewing machine (SM).

If the value of the received data byte is equal to 00 (using the hexadecimal units system), NCPU is instructed by the software (SW) to proceed to the following third step.

Third step of the authentication protocol (AP) is the transmission of said authentication request data signature (AQD) and is implemented by the sewing machine (SM).

As in previous step (see also FIG. 3), microprocessor is instructed to send a series of predefined commands, stored in its memory (SRAM), to sewing machine (SM) communication port. These commands are then converted into a queue of 13 bytes which comprises the authentication request data signature (AQD) which is encapsulated into a data packet and transmitted by the sewing machine (SM) communication port and via the communication link (CL), to the personal computer (PC) communication port.

Personal computer (PC) communication port receives said data packet within a certain time bound. CPU is then charged of transferring it to RAM and undertakes the transfer of received data packet from RAM to the personal computer network card (NC1). Personal computer network card (NC1) utilizes the interceded network (NET) and transmits received data packet to network personal computer network card (NC2). Successively, the network personal computer network card (NC2) receives data packet and NCPU stores it into NRAM where data bytes will be extracted and analyzed.

The analysis phase of this step is actualized by checking the standardized ASCII values of the second, third, fourth, fifth, sixth, seventh, eighth and ninth data byte of the received 13-byte long authentication request data signature (AQD). Validation can be considered as successful if all of the following eight (8) equations are true. In this case, network personal computer (NPC) proceeds to the forth step of the authentication protocol (AP) implementation.
1. The value of the second byte is equal to 43 h which corresponds to the capital letter “C”

2. The value of the third byte is equal to 4 Fh which corresponds to the capital letter “O”
3. The value of the fourth byte is equal to 4 Dh which corresponds to the capital letter “M”
4. The value of the fifth byte is equal to 50 h which corresponds to the capital letter “P”
5. The value of the sixth byte is equal to 55 h which corresponds to the capital letter “U”
6. The value of the seventh byte is equal to 43 h which corresponds to the capital letter “C”
7. The value of the eighth byte is equal to 4 Fh which corresponds to the capital letter “O”
8. The value of the ninth byte is equal to 4 Eh which corresponds to the capital letter “N”

If any of the above statements is false or network personal computer (NPC) encounters a reception timeout, further execution of software (SW) as well as the consequent communication with the sewing machine (SM) is prohibited; authentication protocol (AP) procedure has to be re-launched.

The fourth step of the authentication protocol (AP), concerns the transmission of said authentication response signature (ARS) (see also FIG. 3).

Implementation of this step is assigned to the network personal computer processor (NCPU) which is instructed by the software (SW) to send a command or a sequence of predefined commands to network personal computer network card (NC2); said network card (NC2), in turn, interprets these commands into one data packet that is transmitted though the network (NET) to the personal computer network card (NC1). Successively, CPU transfers said data packet received by personal computer network card (NC1), to memory RAM. CPU then undertakes the transmission of said data packet from RAM to personal computer (PC) communication port. Utilizing the available communications link (CL), data packet is transferred from personal computer (PC) communication port, to the sewing machine (SM) communication port within a certain reception time limit. Microprocessor undertakes the transfer of the received data packet to the memory (SRAM), the extraction of the data byte, as well as the analysis of its value.

If the value of the received data byte is not equal to 8 F (using the hexadecimal units system) or the reception time runs out, microprocessor is instructed to end; further command execution by the microprocessor is inhibited.

If the value of the received data byte is 8 F (using the hexadecimal units system), the microprocessor is instructed to send authentication response data signature (ARD); this procedure will be described in the fifth step of our authentication protocol (AP).

The implementation of the fifth step is assigned to the network personal computer (NPC). As was done in the third step of the authentication procedure (see also FIG. 3), software (SW) instructs NCPU to send a set of predefined commands, to the relevant network card (NC2) of the network personal computer (NPC). These commands are converted into a queue of 13 bytes which comprises the authentication response data signature (ARD) which is then encapsulated into a data packet and transmitted through the interceded network (NET) to the correspondent personal computer network card (NC1). CPU then takes care of the transportation of data packet received from the network card (NC1), to personal computer memory (RAM). Successively, said data packet is transferred by CPU from RAM, to the relevant communications port and, via the communication link (CL), is received by the corresponding communication port of the sewing machine (SM). The reception of data packet is time-bound. Said reception is followed by the transfer of the received data packet from communication port to memory (SRAM) so as to enable microprocessor of actualizing the consequent process of the data bytes extraction and their analysis.

The analysis phase of this step is actualized by checking the ASCII values of the second, third, fourth, fifth, sixth, seventh, eighth and ninth data byte of the received 13-byte authentication response data signature (ARD).

Validation can be considered as successful if all of the following eight equations are true. In this case, sewing machine (SM) proceeds to the sixth step of the authentication protocol (AP) implementation.
1. The value of the second byte is equal to 43 h which corresponds to the capital letter “C”
2. The value of the third byte is equal to 4 Fh which corresponds to the capital letter “O”
3. The value of the fourth byte is equal to 4 Dh which corresponds to the capital letter “M”
4. The value of the fifth byte is equal to 50 h which corresponds to the capital letter “P”
5. The value of the sixth byte is equal to 55 h which corresponds to the capital letter “U”
6. The value of the seventh byte is equal to 43 h which corresponds to the capital letter “C”
7. The value of the eighth byte is equal to 4 Fh which corresponds to the capital letter “O”
8. The value of the ninth byte is equal to 4 Eh which corresponds to the capital letter “N”

If any of the above statements is false or reception time expires, microprocessor waits for a defined number of retries until it receives again the data byte described in the fourth step and the data bytes described in fifth step, sequentially. Failing to successfully validate for the defined number of tries, results in prohibiting any further microprocessor command execution as well as the consequent communication with the network personal computer (NPC) through network (NET). Process of authentication protocol (AP) implementation must be restarted for both network personal computer (NPC) and sewing machine (SM).

The last step of the authentication protocol (AP), concerns the transmission of said authentication confirm signature (ACD). As also presented in FIG. 3, this step is actualized by the sewing machine (SM) microprocessor which sends a command or a sequence of predefined commands to sewing machine (SM) communication port, within a certain reception time limit; communication port, in turn, encapsulates these commands into a data packet that is transmitted though the communications link (CL) to the personal computer (PC) communication port which undertakes the transfer of the received data packet to memory (RAM). CPU then is charged of the transportation of said received data packet from RAM to personal computer (PC) network card (NC1) in order to transfer the data packet, through the network (NET), to network personal computer network card (NC2). Successively, NCPU undertakes the transfer of said received data packet from network card (NC2) to NRAM where the extraction of the data byte and its analysis will take place.

If the value of the received data byte is not equal to 00 (using the hexadecimal units system) or reception time limit runs over, CPU assumes this step as unsuccessful and authentication protocol (AP) procedure must be restarted for both network personal computer (NPC) and sewing machine (SM).

If the value of the received data byte is 00 (using the hexadecimal units system), the software (SW) executed in network personal computer (NPC) assumes that authentication protocol (AP) procedure is successfully completed and the normal cooperation and data exchange with the sewing machine (SM) is launched.

After a successful authentication procedure, the personal computer (PC) is allowed to send stitching data to the sewing machine (SM). This state is valid until the end of the cooperation session.

A cooperation session can be considered as “ended” either when the network personal computer software (SW) execution is terminated by any means or when the sewing machine (SM) operation is terminated by any means or when the communication link (CL) between the personal computer (PC) and the sewing machine (SM) is interrupted or lost, by any means too. Also, a session ends when one stitching data transmission is completed; authentication procedure needs to be re-launched in order to send another pack of stitching data. The case of resetting or restarting either network personal computer (PC) and its software (SW) execution, or sewing machine (SM), is also indicating an ended session. In any of the above cases, in order to re-allow data to be exchanged between personal computer (PC) and the sewing machine (SM), the authentication procedure must be repeated right from the start.

Although some specific embodiments of this invention have been described hereby, the invention is not to be limited by those descriptions, and rather it is to be construed in accordance with the attached claims.

1. An authentication protocol (AP) of authenticating the connection and the exclusive and mutual cooperation of a specific computer software (SW) stored in and executed by an IBM-compatible personal computer (PC) or a network personal computer (NPC), interconnected with a sewing machine (SM), and utilizing a standardized Universal Serial Bus communication link (CL). The fixed sequence of transmitting and receiving data signatures is comprised of the following steps: said personal computer (PC) initializes authentication by issuing and sending authentication initialize signature (AI) which has a hexadecimal value of 8 E (hex) to said sewing machine (SM); if said sewing machine (SM) is in the desired state, it issues and sends to said personal computer (PC), an authentication acknowledge data signature (ACK) which has a hexadecimal value of 00. Sequentially, said sewing machine (SM) issues and sends request data signature (AQD) which is consisted of sequential ASCII-equivalent byte values of “C”, “O”, “M”, “P”, “U”, “C”, “O”, “N”, to said personal computer (PC); said personal computer (PC) then issues and sends authentication response signature (ARS) which has a hexadecimal value of 8 F, to said sewing machine (SM); said sewing machine (SM) issues and sends an authorization response data signature (ARD) which is consisted of sequential ASCII-equivalent byte values of “C”, “O”, “M”, “P”, “U”, “C”, “O”, “N”. On the final step, said sewing machine (SM) issues and sends authentication confirm signature (ACD) which has a hexadecimal value of 00, to inform said personal computer (PC) that the connection is authenticated and established.

2. A method as defined in claim 1, where said communication link (CL) comprises of any type of standardized types and communication ports are also any of the standardized types.

3. A method as defined in claim 1, where said personal computer (PC) is a Palm PC or is a non-IBM compatible personal computer, at least including a processor, a communication port and a memory device.

4. A method as defined in claim 1, where said software (SW) is stored in a separate mass storage device or a data storage media properly connected to said personal computer (PC).

5. A method as defined in claim 1, where said software (SW) is stored in and executed by a network personal computer (NPC) connected to said personal computer (PC) through the properly configured said computer network (NET).

6. A method as defined in claim 5, where said network personal computer (NPC) is a Palm PC or is non-IBM compatible, at least including a processor, a communication port and a memory device.

7. A method as defined in claim 5, where said software (SW) is stored in a separate mass storage device or a data storage media, properly connected to said network personal computer (NPC) which executes said software (SW).

8. A method as defined in claim 5, where said software (SW) is stored in a separate mass storage device or a data storage media properly connected to said network (NET).
